(19) United States
(12) Patent Application Publication
(10) Pub. No.: US 2009/0068476 A1
(43) Pub. Date: Mar. 12, 2009

(54) Laminate and pneumatic tire using the same

(75) Inventor: Yoshiaki Kirino, Kanagawa (JP)

Correspondence Address: CONNOLLY BOVE LODGE & HUTZ LLP, 1875 EYE STREET, N.W., SUITE 1100, WASHINGTON, DC, 20006, US

(73) Assignee: THE YOKOHAMA RUBBER CO., LTD., Tokyo (JP)

(21) Appl. No.: 11/913,632

(22) PCT Filed: May 2, 2006
(86) PCT No.: PCT/JP2006/309526

§ 371 Date: Nov. 5, 2007

(30) Foreign Application Priority Data
May 9, 2005 (JP) 2005-136070

(51) Int. Cl. B32B 27/00

(52) U.S. Cl. 428/448; 428/523

(57) ABSTRACT

A laminate containing a layer of a thermoplastic elastomer (A) containing an elastomer component dispersed in a thermoplastic resin matrix in which, a layer of an adhesive composition (B) containing a styrene-based copolymer having double bonds, a vulcanization agent and/or a vulcanization accelerator and a reinforcing filler, and a layer of an unvulcanized rubber composition (C), wherein the laminate is made integral at the time of vulcanization of rubber, whereby the adhesiveness of the laminate between a thermoplastic elastomer composition layer and unvulcanized rubber composition layer is improved.

### TECHNICAL FIELD

The present invention relates to a laminate and a pneumatic tire using the same, more particularly relates to a laminate of a thermoplastic elastomer layer and a rubber layer having improved adhesiveness suitable for an air barrier layer and a tie rubber layer and/or a carcass layer of a pneumatic tire and a pneumatic tire using the same.

### BACKGROUND ART

The technology of using a film of a thermoplastic resin and a thermoplastic elastomer composition for the inner liner (or an air permeation preventive layer) of a pneumatic tire is known (see, for example, Japanese Patent Publication (A) No. 10-25375). This film does not have a sufficient adhesiveness between a carcass layer and a tie rubber layer (i.e., buffer material between the carcass layer and the inner liner). Therefore, it has been proposed to coat or coextrude with the film an adhesive so as to secure the adhesiveness (see, for example, Japanese Patent No. 3320420 and Japanese Patent Publication (A) No. 11-240108).

As the adhesive used when producing a laminate of said thermoplastic elastomer film and a rubber, an ESBS (i.e., epoxy modified styrene-butadiene-styrene block copolymer), tackifier, peroxide (or thiuram-based vulcanization accelerator) are utilized. However, when materials are being developed for improving the gas barrier property of the thermoplastic elastomer film used as an inner liner, the thermoplastic elastomer per se is being changed to thicker and harder materials. Thus, development of a new adhesive, which can replace conventional adhesives, has become necessary.

### DISCLOSURE OF THE INVENTION

Accordingly, an object of the present invention is to solve the problem of securing said adhesiveness and to improve the adhesiveness of a thermoplastic elastomer layer (film) and a rubber layer (a tie rubber layer and/or a carcass layer) and remarkably improve the peeling resistance performance.

In accordance with the present invention, there are provided a laminate comprising a layer of a thermoplastic elastomer (A) comprising an elastomer component dispersed in a thermoplastic resin matrix, a layer of an adhesive composition (B) containing a styrene-based copolymer having double bonds, a vulcanization agent and/or a vulcanization accelerator and a reinforcing filler and a layer of an unvulcanized rubber composition (C), wherein the laminate is made integral at the time of vulcanization of rubber and a pneumatic tire using the same.

In accordance with the present invention, there are provided a laminate comprising a layer of a thermoplastic elastomer (A) comprising an elastomer component dispersed in a thermoplastic resin matrix, a layer of an adhesive composition (B′) containing a styrene-based copolymer having double bonds and a 0.5 to 10 parts by weight, based upon 100 parts by weight of the styrene-based copolymer (B′), of a thiuram-based vulcanization accelerator and a layer of an unvulcanized rubber composition (C), wherein the laminate is made integral at the time of vulcanization of rubber and a pneumatic tire using the same.

According to the present invention, by compounding reinforcing filler conventionally used for rubber, such as carbon black, silica into the adhesive, the adhesiveness of the harder thermoplastic elastomer layer (or film) and a rubber layer can be improved. This is effective for the bonding of a tire use inner liner utilizing film.

The singular form used in the Description and the attached Claims should be understood as including the plural, except when otherwise clear from the context.

### BEST MODE FOR CARRYING OUT THE INVENTION

The inventors engaged in research to solve the above problems and, as a result, discovered that by making integral, at the time of vulcanization of rubber, a laminate comprising a thermoplastic elastomer (A) comprising an elastomer component dispersed in a thermoplastic resin matrix, an adhesive composition (B) containing a styrene-based copolymer having double bonds, a vulcanization agent and/or a vulcanization accelerator and further a reinforcing filler and an unvulcanized rubber composition (C), the peeling resistance between the layer of the thermoplastic elastomer (A) (including film, same hereinbelow) and the layer of rubber (C) is remarkably improved, whereby the present invention is completed.

The inventors further discovered that a laminate comprising a layer of a thermoplastic elastomer (A) comprising an elastomer component dispersed in a thermoplastic resin matrix, a layer of an adhesive composition (B′) containing a styrene-based copolymer having double bonds and 0.5 to 10 parts by weight, based upon 100 parts by weight of that copolymer (B′) of a thiuram-based vulcanization accelerator and a layer (C) of an unvulcanized rubber composition, which is made integral at the time of vulcanization of rubber, is superior in the peeling resistance performance between the layer of the thermoplastic elastomer (A) and the layer of the rubber (C).

The laminate according to the present invention is a laminate comprising a layer of a thermoplastic elastomer composition (A) comprising an elastomer dispersed in a matrix of a thermoplastic resin and a layer of an unvulcanized rubber composition (C) laminated together via a layer of an adhesive (B). The thermoplastic elastomer composition (A) preferably has an air permeation coefficient of 25×10⁻¹²cc·cm/cm²·sec·cmHg or less and a Young's modulus of 1 to 500 MPa. This thermoplastic elastomer (A) can be obtained by, for example, molding by extrusion molding, etc. a thermoplastic elastomer comprising a matrix (continuous phase) of at least one thermoplastic resin such as a polyamide-based resin, polyester-based resin, polynitrile-based resin, polymethacrylate-based resin, polyvinyl-based resin, cellulose-based resin, fluorine-based resin and imide-based resin, in which at least one elastomer such as a diene-based rubber or its hydrogenate, olefin-based rubber, halogen-containing rubber, silicone rubber, sulfur-containing rubber, fluororubber, thermoplastic elastomer, etc. is dispersed. Specifically, it can be obtained by preliminarily melt mixing the thermoplastic resin and the elastomer components by a twin-screw extruder, etc. to disperse the elastomer component in the thermoplastic resin, which forms the continuous phase. When vulcanizing the elastomer component, the vulcanization agent is added while mixing or the vulcanization agent is preliminarily blended into the elastomer component and the elastomer component is dynamically vulcanized. Further, the various types of compounding agents (excluding vulcanization agents) added to the thermoplastic resin and/or elastomer component may be added during the above mixing, but they are preferably mixed in beforehand before mixing. The kneading machine used for kneading the thermoplastic resin and elastomer component is not particularly limited. A screw extruder, kneader, Banbury mixer, twin-screw extruder, etc. may be mentioned, but among these, a twin-screw extruder is preferably used. Note that methods for production a film of the thermoplastic elastomer composition etc. are described in further detail in, for example, Japanese Patent Publication (A) No. 8-258506 and other documents. The present invention can also be carried out by the methods described in these publications.

As the matrix resin of the thermoplastic elastomer composition (A) comprising a thermoplastic matrix, in which an elastomer component is dispersed, according to the present invention, for example, polyamide-based resins (e.g., Nylon 6 (N6), Nylon 66 (N66), Nylon 46 (N46), Nylon 11 (N11), Nylon 12 (N12), Nylon 610 (N610), Nylon 612 (N612), Nylon 6/66 copolymer (N6/66), Nylon 6/66/610 copolymer (N6/66/610), Nylon MXD6 (MXD6), Nylon 6T, Nylon 6/6T copolymer, Nylon 66/PP copolymer, Nylon 66/PPS copolymer), and their N-alkoxyalkylates, for example a methoxymethylate of 6-Nylon, a methoxymethylate of 6-610-Nylon, a methoxymethylate of 612-Nylon, polyester-based resins (e.g., polybutylene terephthalate (PBT), polyethylene terephthalate (PET), polyethylene isophthalate (PEI0), PET/PEI copolymer, polyacrylate (PAR), polybutylene naphthalate (PBN), liquid crystal polyester, polyoxyalkylene diimidic acid/polybutylene terephthalate copolymer and other aromatic polyesters), polynitrile-based resins (e.g., polyacrylonitrile (PAN), polymethacrylonitrile, acrylonitrile/styrene copolymer (AS), methacrylonitrile/styrene copolymer, methacrylonitrile/styrene/butadiene copolymer), polymethacrylate-based resins (e.g., polymethyl methacrylate (PMMA), polyethyl methacrylate), polyvinyl-based resins (e.g., vinyl acetate, polyvinyl alcohol (PVA), vinyl alcohol/ethylene copolymer (EVOH), polyvinylidene chloride (PDVC), polyvinyl chloride (PVC), vinyl chloride/vinylidene chloride copolymer, vinylidene chloride/methyl acrylate copolymer, vinylidene chloride/acrylonitrile copolymer), cellulose-based resins (e.g., cellulose acetate, cellulose acetate butyrate), fluorine-based resins (e.g., polyvinylidene fluoride (PVDF), polyvinyl fluoride (PVF), polychlorofluoroethylene (PCTFE), tetrafluoroethylene/ethylene copolymer), imide-based resins (e.g., aromatic polyimide (PI)), etc. may be mentioned. These resins may be used alone or in any blend thereof.

On the other hand, as the elastomer present as a dispersed layer in the thermoplastic elastomer composition (A) of the present invention, for example, diene-based rubbers and their hydrogenates (e.g., NR, IR, epoxylated natural rubber, SBR, BR (high cis-BR and low cis-BR) and their maleate adducts, NBR, hydrogenated NBR, hydrogenated SBR), olefin-based rubbers (e.g., ethylene propylene rubber (EPDM,EPM), maleic acid modified ethylene propylene rubber (M-EPM), IIR, isobutylene and aromatic vinyl or diene-based monomer copolymers, acryl rubber (ACM), ionomer), halogen-containing rubbers (e.g., brominated butyl rubber (Br-IIR), chlorinated butyl rubber (Cl-IIR), a bromide of an isobutylene paramethylstyrene copolymer (Br-IPMS), chloroprene rubber (CR), hydrin rubber (CHR, CHC), chlorosulfonated polyethylene (CSM), chlorinated polyethylene (CM), maleic acid modified chlorinated polyethylene (M-CM)), silicone rubbers (e.g., methylvinyl silicone rubber, dimethyl silicone rubber, methylphenylvinyl silicone rubber), sulfur-containing rubbers (e.g., polysulfide rubber), fluororubbers (e.g., vinylidene fluoride-based rubbers, fluorine-containing vinylether-based rubbers, tetrafluoroethylene-propylene-based rubbers, fluorine-containing silicone-based rubbers and fluorine-containing phosphagen-based rubbers), thermoplastic elastomers (e.g., styrene-based elastomers, polyolefin-based elastomers, polyester-based elastomers, polyurethane-based elastomers, polyamide-based elastomers), etc. may be mentioned. These may be used alone or in any blends thereof.

The unvulcanized rubber composition (C) forming the laminate according to the present invention is a composition containing rubber component such as a diene-based rubber. This composition (C) may be, for example, formed into a sheet and laminated over the layer (film) of the composition (A) through an adhesive (B) to form a laminate. The laminate can be directly used as a carcass layer or tie rubber layer of a pneumatic tire for a conventional tire manufacturing process.

As the rubber component usable for the diene-based rubber composition (C) of the present invention, for example, any diene-based rubber capable of being used for tires etc. may be used, specifically, diene-based rubbers such as various types of natural rubbers (NR), various types of polybutadiene rubbers (BR), various types of polyisoprene rubbers (IR), various types of styrene-butadiene copolymer rubbers (SBR), acrylonitrile-butadiene copolymer rubbers (NBR), styrene-isoprene copolymer rubbers, styrene-isoprene-butadiene copolymer rubbers, or butyl rubber, halogenated butyl rubber, ethylene-propylene-diene copolymer rubber, etc. may be mentioned. These may be used alone or in any blend thereof. As a rubber component other than a diene-based rubber, an ethylene-propylene copolymer rubber, ethylene-octene copolymer rubber, etc. may be used.

The adhesive composition (B) usable for the laminate according to the present invention must have a ratio of the value of the 100% modulus with respect to the value of the 50% modulus after vulcanization satisfying the above requirement, that is, 1.41 to 2.45, preferably 1.62 to 1.89. If this ratio is small, a sufficient adhesiveness cannot be obtained, and, therefore, this is not preferable, while conversely if large, the processability of the adhesive composition is decreased, and, therefore, this is also not preferable. While not particularly limited, a conventional one may be used. As the styrene-based polymer having double bonds forming the adhesive composition of the present invention, for example any polymer generally used as an adhesive use polymer for a rubber layer etc. in the past, for example, an SBS (styrene-butadiene-styrene block copolymer), SIS (styrene-isoprene-styrene block copolymer), SEBS (styrene-ethylene-butadiene-styrene block copolymer), SIBS (styrene-isoprene-butadiene-styrene block copolymer), or other polymer, into which a tackifier is compounded, may be obtained. A styrene-based polymer having double bonds improves the adhesiveness with a thermoplastic elastomer, and, therefore, part or all of the dienes are preferably epoxy-modified. Further, among these, an ESBS (epoxy-modified styrene-butadiene-styrene block copolymer) is preferable. Further, if necessary, it is also possible to use a blend of an epoxy-modified polymer and a unmodified polymer. The usable tackifier is not particularly limited. A general tackifier may be used. As specific examples, a terpene resin, modified terpene resin, pinene resin, terpene phenol resin, rosin-based resin, C5-based petroleum resin, C9-based petroleum resin, DCPD-based petroleum resin, styrene-based resin, coumarone resin, alkyl phenol resin, etc. may be mentioned. The compounding amount thereof is not particularly limited, but is preferably 10 to 200 parts by weight, more preferably 20 to 100 parts by weight or so, based upon 100 parts by weight of an adhesive polymer component.

The adhesive composition of the present invention also includes a vulcanization agent and/or a vulcanization accelerator and a reinforcing filler. As the vulcanization agent (a cross-linking agent) usable in the present invention, any vulcanization agent used for vulcanization of rubber in the past, for example, as sulfur-based ones, various types of sulfur (powdered sulfur, precipitated sulfur, insoluble sulfur, etc.), as peroxide-based ones, for example, benzoyl peroxide, t-butyl hydroperoxide, 2,4-dichlorodibenzoyl peroxide, 2,5-dimethyl-2,5-di(t-butylperoxy)hexane, 2,5-dimethylhexane-2,5-di(peroxybenzoate), etc. may be mentioned.

As the vulcanization accelerator compounded into the adhesive composition of the present invention, a general rubber use vulcanization accelerator may be used. Specifically, a guanidine-based (e.g., diphenyl guanidine), thiazole-based (e.g., 2-mercaptobenzothiazole and dibenzothiazyl disulfide), sulfenamide-based (e.g., N-cyclohexyl-2-benzothiazyl sulfenamide, N-t-butyl-2-benzothiazyl sulfenamide, N,N-dicyclohexyl-2-benzothiazoyl sulfenamide), thiuram-based (e.g., tetramethyl thiuram disulfide, tetraethyl thiuram disulfide, tetrakis(2-ethylhexyl) thiuram disulfide, tetrabenzyl thiuram disulfide and their monosulfide compounds), dithio acid salt-based, thiourea-based and other ones may be mentioned.

The compounding amount of the vulcanization agent and/or the vulcanization accelerator is not particularly limited, but 0.5 to 10 parts by weight, per 100 parts by weight of the styrene-based copolymer, are preferably 0.5 to 3 parts by weight, per 100 parts by weight of the styrene-based copolymer, are more preferably compounded. If the compounding amount is small, a sufficient adhesiveness is liable not to be obtained, while conversely if high, scorching is liable to be caused during processing.

According to the present invention, various types of carbon blacks, various types of silicas, and other reinforcing fillers widely used, in the past, for rubber are further blended into the adhesive composition. The type of these fillers are not particularly limited. The compounding amount is not particularly limited, but 10 to 80 parts by weight, per 100 parts by weight of styrene-based copolymer, is preferable, 10 to 30 parts by weight is more preferable.

The rubber composition according to the present invention may contain therein, in addition to the above components, carbon black, silica or another filler, a vulcanization or cross-linking agent, vulcanization or cross-linking accelerator, various types of oils, antioxidants, plasticizers, and other various types of additives generally used for tire use or other rubber composition use. These additives may be mixed by a general method to obtain a composition which is then used for vulcanization or cross-linking. The amounts of these additives may be made the conventional general amounts so long as the object of the present invention is not impaired.

### EXAMPLES

Examples will now be used to further explain the present invention, but the scope of the present invention is by no means limited to these Examples.

### Examples 1 to 18 and Comparative Example 1

### Preparation of Thermoplastic Elastomer Composition Layer (Air Barrier Layer)

In each of the formulations shown in Table I, the compounding agents are charged into a twin-screw extruder, mixed at a set temperature of 200° C., extruded into strands having a diameter of about 3 mm, and processed into pellet shapes by a strand cutter. These were formed by a T-die having a width of 400 mm into a sheet shape having a thickness of 0.2 mm.

TABLE I
Thermoplastic resin component

| | | | |
|---|---|---|---|
| Nylon 6/66 | Amylan CM6001 (made by | 40 | parts by weight |
| | Toray) | | |

Elastomer component

| | | | |
|---|---|---|---|
| Br-IPMS | MDX90-10 (made by Exxon | 60 | parts by weight |
| | Mobil Chemical) | | |

Vulcanization components

| | | | |
|---|---|---|---|
| Zinc white | Zinc White No. 3 (made | 1 | part by weight |
| | by Seido Chemical) | | |
| Stearic acid | Beads Stearic Acid (made | 1 | part by weight |
| | by NOF Corporation) | | |

### Preparation of Adhesive Composition Sample

In each of the formulations shown in Table II, the compounding agents are charged into a single-screw extruder, mixed at a set temperature of 110° C., extruded into strands having a diameter of about 3 mm, and processed into pellet shapes by a strand cutter. These were shaped by a T-die having a width of 400 mm into a sheet shape having a thickness of 0.03 mm.

TABLE II

| | Comp. | Ex. | Ex. | | | | Ex. | | | | |
|---|---|---|---|---|---|---|---|---|---|---|---|
| Formulation (parts by weight) | Ex. | 1 | 2 | 3 | 4 | 5 | 6 | 7 | 8 | 9 | 10 |
| ESBS*¹ | 100 | 100 | 100 | 100 | 100 | 100 | 100 | 100 | 100 | 100 | 100 |
| Tackifier*² | 60 | 60 | 60 | 60 | 60 | 60 | 60 | 60 | 60 | 60 | 60 |
| Carbon black*³ | — | 30 | 30 | 30 | 30 | 30 | 30 | 30 | 30 | 10 | 80 |
| Silica*⁴ | — | — | — | — | — | — | — | — | — | — | — |
| Zinc white*⁵ | 5 | 5 | 5 | 5 | 5 | 5 | 5 | 5 | 5 | 5 | 5 |
| Stearic acid*⁶ | 1 | 1 | 1 | 1 | 1 | 1 | 1 | 1 | 1 | 1 | 1 |
| Peroxide*⁷ | 0.5 | 0.5 | — | — | — | — | — | — | — | — | — |
| Thiuram disulfide*⁸ | — | — | 3 | — | — | — | — | 0.5 | 10 | 3 | 3 |
| Thiuram disulfide*⁹ | — | — | — | 3 | — | — | — | — | — | — | — |
| Thiuram disulfide*¹⁰ | — | — | — | — | 3 | — | — | — | — | — | — |
| Thiuram disulfide*¹¹ | — | — | — | — | — | 3 | — | — | — | — | — |
| Thiuram monosulfide*¹² | — | — | — | — | — | — | 3 | — | — | — | — |
| (Total) | (166.5) | (196.5) | (199) | (199) | (199) | (199) | (199) | (196.5) | (206) | (179) | (229) |
| Modulus ratio (100% M/50% M) | 1.21 | 1.62 | 1.64 | 1.63 | 1.64 | 1.62 | 1.84 | 1.64 | 1.63 | 1.41 | 1.89 |
| Bonding test | Poor | Good | Very | Very | Very | Very | Very | Very | Very | Very | Very |
| | | | good | good | good | good | good | good | good | good | good |

| | Ex. | | | Ex. | | | | |
|---|---|---|---|---|---|---|---|---|
| Formulation (parts by weight) | 11 | 12 | 13 | 14 | 15 | 16 | 17 | 18 |
| ESBS*¹ | 100 | 100 | 100 | 100 | 100 | 100 | 100 | 100 |
| Tackifier*² | 60 | 60 | 60 | 60 | 60 | 60 | 60 | 60 |
| Carbon black*³ | — | — | — | — | — | — | — | — |
| Silica*⁴ | 10 | 30 | 60 | — | — | — | — | — |
| Zinc white*⁵ | 5 | 5 | 5 | 5 | 5 | 5 | 5 | 5 |
| Stearic acid*⁶ | 1 | 1 | 1 | 1 | 1 | 1 | 1 | 1 |
| Peroxide*⁷ | — | — | — | — | — | — | — | — |
| Thiuram disulfide*⁸ | 3 | 3 | 3 | 3 | — | — | — | — |
| Thiuram disulfide*⁹ | — | — | — | — | 3 | — | — | — |
| Thiuram disulfide*¹⁰ | — | — | — | — | — | 3 | — | — |
| Thiuram disulfide*¹¹ | — | — | — | — | — | — | 3 | — |
| Thiuram monosulfide*¹² | — | — | — | — | — | — | — | 3 |
| (Total) | (179) | (199) | (229) | (169) | (169) | (169) | (169) | (169) |
| Modulus ratio (100% M/50% M) | 1.52 | 1.86 | 2.45 | 1.22 | 1.23 | 1.22 | 1.22 | 1.23 |
| Bonding test | Very | Very | Very | Good | Good | Good | Good | Good |
| | good | good | good | | | | | |

Table II notes
*¹Epofriend AT501 ESBS made by Daicel Chemical
*²YS Resin D-105 tackifier made by Yasuhara Chemical
*³Diablack G GPF made by Mitsubishi Chemical
*⁴Nipsil AQ made by Nippon Silica
*⁵Zinc white made by Seido Chemical
*⁶Stearic acid made by NOF Corporation
*⁷Parkerdox 14 made by Kayaku Akzo
*⁸Noccelar TOT-N made by Ouchi Shinko Chemical Industrial
*⁹Perkacit TBzTD made by Flexys
*¹⁰Sansera TT made by Sanshin Chemical Industry
*¹¹Sansera TE-G made by Sanshin Chemical Industry
*¹²Sansera TS-G made by Sanshin Chemical Industry

### Preparation of Carcass Rubber Layer

In each of the formulations shown in Table III, the compounding agents other than the vulcanization agent were mixed in a 1.7-liter Banbury mixer at a set temperature of 70° C. for 5 minutes to obtain a master batch. Next, an 8-inch roll was used to mix the vulcanization agent to obtain a 2-mm thick unvulcanized rubber composition.

TABLE IV

| | | | |
|---|---|---|---|
| NR | RSS#1 | 65 | parts by weight |
| SBR | Nipol 1502 (made by Nippon Zeon) | 20 | parts by weight |
| BR | Nipole BR1220 (made by Nippon Zeon) | 15 | parts by weight |
| GPF | Diablack G (Mitsubishi Chemical) | 50 | parts by weight |
| carbon | | | |
| Aromatic | Coumorex 300 (made by Nippon Oil) | 8 | parts by weight |
| oil | | | |
| Zinc | Zinc White No. 3 (Seido Chemical) | 5 | parts by weight |
| white | | | |
| RD | Nocrac 224 (Ouchi Shinko Chemical | 1 | part by weight |
| | Industrial) | | |
| DM | Noccelar DM (Ouchi Shinko Chemical | 1 | part by weight |
| | Industrial) | | |
| Sulfur | Gold Flower brand sulfur powder | 2 | parts by weight |
| | 150 mesh (Tsurumi Chemical) | | |

### Preparation of Laminate Sample

Sheets of combinations of thermoplastic elastomers/adhesive compositions/carcass rubber layers cut into 15 cm×15 cm were successively laminated and vulcanized at 170° C. for 10 minutes to obtain laminates.

### Evaluation Test Method

Modulus ratio: Each adhesive composition alone of Table II was formed into a sheet having a thickness of 1 mm and measured by JIS K 6251 for moduli at the time of 50% and 100% elongation. Using the moduli thus measured, the value of the 100% modulus divided by the 50% modulus was used as the modulus ratio.

Bonding test: Each laminate sample was cut into a strip shape having a width of 25 mm and a length of 100 mm, then thermoplastic elastomer film was given a cut at its center in the width direction to prepare a sample. This was tested by an Uejima Seisakusho Dematia crack tester with a chuck distance of 60 mm, a stroke of 10 mm, and continuous tensile strain applied repeated 500,000 times, then the peeling of the film from the cut part was visually observed and evaluated as follows:

Very good: No peeling of film seen at all

Good: Very slight peeling of not more than 2 mm width from the cut seen (destroying material of rubber or adhesive)

Poor: Major peeling exceeding 2 mm width from cut occurred resulting in interfacial peeling

### INDUSTRIAL APPLICABILITY

According to the present invention, it is possible to obtain a laminate of a thermoplastic elastomer composition/an adhesive composition/an unvulcanized rubber composition having improved adhesiveness, and, therefore, the invention is useful as an air barrier layer of a pneumatic tire.

1. A laminate comprising a layer of a thermoplastic elastomer (A) comprising an elastomer component dispersed in a thermoplastic resin matrix, a layer of an adhesive composition (B) containing a styrene-based copolymer having double bonds, a vulcanization agent and/or a vulcanization accelerator and a reinforcing filler and a layer of an unvulcanized rubber composition (C), the laminate being made integral at the time of vulcanization of rubber.

2. A laminate as claimed in claim 1, wherein the adhesive composition (B) comprises 100 parts by weight of the styrene-based copolymer having double bonds, 0.5 to 10 parts by weight of the vulcanization agent and/or vulcanization accelerator and 10 to 80 parts by weight of the reinforcing filler.

3. A laminate as claimed in claim 1, wherein the reinforcing filler of the adhesive composition (B) is carbon black or silica.

4. A laminate as claimed in claim 1, wherein the vulcanization accelerator of the adhesive composition (B) is a thiuram-based vulcanization accelerator.

5. A laminate as claimed in claim 1, wherein the vulcanization agent of the adhesive composition (B) is a peroxide.

6. A laminate as claimed in claim 1, wherein a ratio of a 100% modulus to a 50% modulus of the adhesive composition (B) after vulcanization is 1.41 to 2.45.

7. A pneumatic tire using the laminate according to claim 1.

8. A laminate comprising a layer of a thermoplastic elastomer (A) comprising an elastomer component dispersed in a thermoplastic resin matrix, a layer of an adhesive composition (B′) containing a styrene-based copolymer having double bonds and a 0.5 to 10 parts by weight, based upon 100 parts by weight of the styrene-based copolymer (B′), of a thiuram-based vulcanization accelerator and a layer of an unvulcanized rubber composition (C), the laminate being made integral at the time of vulcanization of rubber.

9. A laminate as claimed in claim 2, wherein the reinforcing filler of the adhesive composition (B) is carbon black or silica.

10. A laminate as claimed in claim 2, wherein the vulcanization accelerator of the adhesive composition (B) is a thiuram-based vulcanization accelerator.

11. A laminate as claimed in claim 3, wherein the vulcanization accelerator of the adhesive composition (B) is a thiuram-based vulcanization accelerator.

12. A laminate as claimed in claim 2 wherein the vulcanization agent of the adhesive composition (B) is a peroxide.

13. A laminate as claimed in claim 3, wherein the vulcanization agent of the adhesive composition (B) is a peroxide.

14. A laminate as claimed in claim 2, wherein a ratio of a 100% modulus to a 50% modulus of the adhesive composition (B) after vulcanization is 1.41 to 2.45.

15. A laminate as claimed in claim 3, wherein a ratio of a 100% modulus to a 50% modulus of the adhesive composition (B) after vulcanization is 1.41 to 2.45.

16. A laminate as claimed in claim 4, wherein a ratio of a 100% modulus to a 50% modulus of the adhesive composition (B) after vulcanization is 1.41 to 2.45.

17. A laminate as claimed in claim 5, wherein a ratio of a 100% modulus to a 50% modulus of the adhesive composition (B) after vulcanization is 1.41 to 2.45.

18. A pneumatic tire using the laminate according to claim 2.

19. A pneumatic tire using the laminate according to claim 3.

20. A pneumatic tire using the laminate according to claim 4.
